(19) United States
(12) Patent Application Publication
(10) Pub. No.: US 2026/0169774 A1
(43) Pub. Date: Jun. 18, 2026

(54) DEVICE-SPECIFIC INTERCEPTION FOR INPUT/OUTPUT DEVICES IN GUESTS OF HYPERVISOR

(71) Applicant: International Business Machines Corporation, Armonk, NY (US)

(72) Inventors: Richard John Moore, Waterlooville (GB); Richard P. Tarcza, Kingston, NY (US); Andreas Vischer, Altdorf (DE); Walter Church, IV, Scotch Plains, NJ (US)

(21) Appl. No.: 18/980,061

(22) Filed: Dec. 13, 2024

(51) Int. Cl. G06F 9/455

(52) U.S. Cl. CPC G06F 9/45545; G06F 9/45558; G06F 2009/45579

(57) ABSTRACT

A present invention embodiment provides a device-specific interception of I/O instructions in a hypervisor environment. A hypervisor is provided with a device structure that includes a device-based interception control value for each of a plurality of devices of a guest of the hypervisor, wherein each device-based interception control value indicates whether input/output (I/O) of a particular device is intercepted or interpreted by the hypervisor. I/O instructions are received from the plurality of devices of the guest. The hypervisor determines that a particular I/O instruction for each device are to be intercepted or interpreted by the hypervisor based on the device-based interception control value of each device. The I/O instructions are executed by intercepting each I/O instruction issued by each particular device that is determined to be intercepted and interpreting each I/O instruction issued by each particular device that is determined to be interpreted

### BACKGROUND

### 1. Technical Field

Present invention embodiments relate to hypervisors and virtual machines, and more specifically, to the device-specific interception of virtual machine input/output (I/O) by a hypervisor.

### 2. Discussion of the Related Art

A hypervisor refers to software and/or hardware that enables multiple operating systems, called guests or virtual machines, to run concurrently on a single physical computing device. A hypervisor manages physical resources, such as CPU, memory, storage, and networking, by allocating the resources to the guests, enabling each guest to operate as if it had its own dedicated hardware. When a guest issues input/output (I/O) instructions, the instructions may be intercepted by the hypervisor, meaning that the hypervisor simulates the instructions on behalf of the guest. Alternatively, I/O instructions can be interpreted by a hypervisor, in which case the instructions are not intercepted but are instead provided to physical dedicated devices for execution without additional involvement by the hypervisor.

### SUMMARY

According to one embodiment of the present invention, a system is provided for device-specific interception of I/O instructions in a hypervisor environment. A hypervisor is provided with a device structure that includes a device-based interception control value for each of a plurality of devices of a guest of the hypervisor, wherein each device-based interception control value indicates whether input/output (I/O) of a particular device is intercepted or interpreted by the hypervisor. I/O instructions are received from the plurality of devices of the guest. The hypervisor determines that a particular I/O instruction for each device are to be intercepted or interpreted by the hypervisor based on the device-based interception control value of each device. The I/O instructions are executed by intercepting each I/O instruction issued by each particular device that is determined to be intercepted and interpreting each I/O instruction issued by each particular device that is determined to be interpreted. Embodiments of the present invention further include a method and computer program product for device-specific interception of I/O instructions in a hypervisor environment in substantially the same manner described above.

### BRIEF DESCRIPTION OF THE DRAWINGS

Generally, like reference numerals in the various figures are utilized to designate like components.

FIG. 1 is a diagrammatic illustration of an example computing environment according to an embodiment of the present invention.

FIG. 2 is a block diagram of hypervisor code according to an embodiment of the present invention.

FIG. 3 is a block diagram of a virtualization environment according to an embodiment of the present invention.

FIG. 4 is a flowchart of a method for executing guest instructions in a hypervisor environment according to an embodiment of the present invention.

FIG. 5 is a flowchart of a method for performing guest instruction interception control in a hypervisor environment according to an embodiment of the present invention.

FIG. 6 is a block diagram of a virtualization environment according to an embodiment of the present invention.

### DETAILED DESCRIPTION

A present invention embodiment relates to hypervisors and virtual machines, and more specifically, to the device-specific interception of virtual machine input/output (I/O) by a hypervisor. An I/O instruction refers to a command issued by a virtual machine (e.g., a guest) to an I/O device, such as a processor, storage, memory, network interface, or other peripheral hardware. While devices may appear as physical hardware from the perspective of a guest, the devices may be virtualized by the hypervisor, meaning that the hypervisor intercepts and manages the instructions as the guest may not have access to the underlying physical hardware. This enables multiple guests to run on a same physical computing device by sharing the underlying physical resources.

However, in some cases it is beneficial to implement a guest's device directly using physical hardware rather than a virtualized device. In such cases, the hypervisor does not intercept I/O instructions, but instead interprets the instructions by dedicating a hardware device to the guest operating system. Using a dedicated device improves performance of the guest, as the guest does not have to compete with other guests for the dedicated resource.

In a hybrid environment, a hypervisor may interpret (i.e., use dedicated hardware) I/O for some guest devices, and may intercept (i.e., simulate) I/O for other guest devices. However, the interception control in conventional hypervisor architectures is limited to classes of devices rather than specific individual devices. For example, in order to interpret I/O for a Peripheral Component Interconnect (PCI) device, all of the PCI devices must therefore be interpreted. The reason for this limitation is because the interception control of conventional techniques is implemented in a state description, which is a data structure of the hypervisor that defines the state of a guest, and includes various execution controls, one of which controls interpretation vs. interception for each class of devices.

The embodiments presented herein address this problem by providing a novel interception control in a device structure for each device of a guest. Since the I/O instructions of devices can be optionally intercepted or interpreted on a per-device basis, present invention embodiments improve computing by optimizing execution of virtual machines in a manner that more efficiently allocates computing resources. Thus, present invention embodiments improve the field of virtualization by reducing computing resource requirements (i.e., processing utilization, memory utilization, storage access utilization, network utilization, etc.) since critical operations of a guest can be directly provided to the underlying physical hardware when needed, and can share the hardware when devices are instead virtualized. This approach also reduces computing resource requirements by eliminating the need for shadow queues when I/O of devices is interpreted, since the memory queue is instead directly provided to hardware. Moreover, present embodiments improve debugging, auditing, and system optimization, as devices can be traced on a per-device level by intercepting I/O instructions of individual devices without having to intercept all of the I/O instructions for every device of that class. This enables specific devices to be analyzed more effectively without disrupting other devices.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

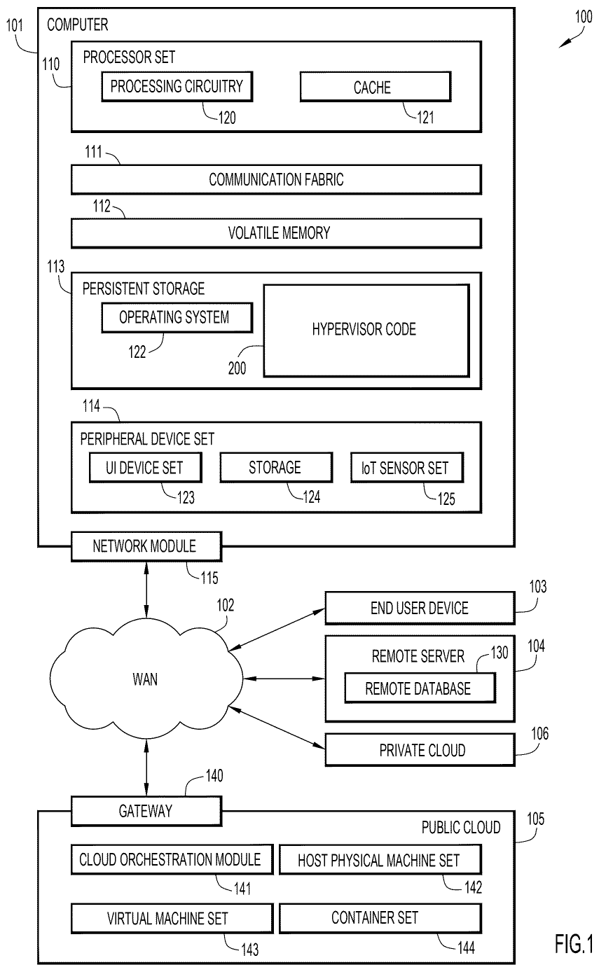

Referring to FIG. 1, computing environment 100 contains an example of an environment for the execution of at least some of the computer code involved in performing the inventive methods, such as hypervisor code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

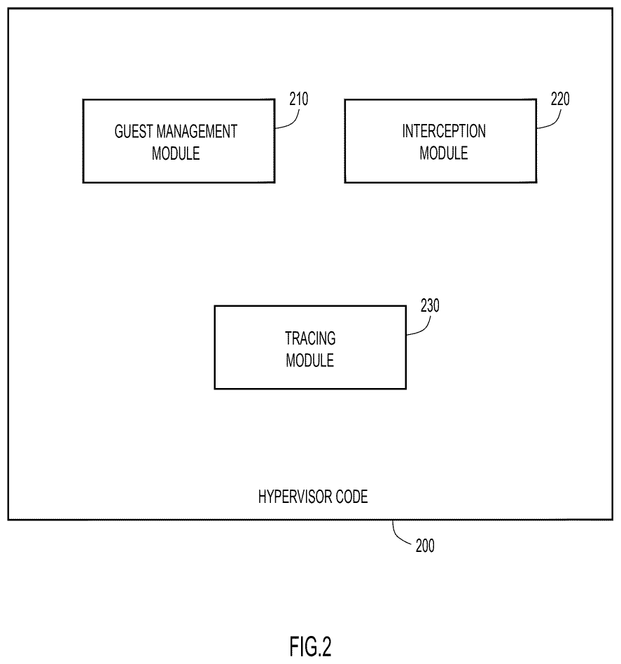

A block diagram of hypervisor code 200 according to an embodiment of the present invention is illustrated in FIG. 2. Specifically, hypervisor code 200 includes at least a guest management module 210, an interception module 220, and a tracing module 230. Guest management module 210, interception module 220, and tracing module 230 may include one or more modules or units to perform various functions of present invention embodiments described herein. Guest management module 210, interception module 220, and tracing module 230 may be implemented by any combination of any quantity of software and/or hardware modules or units, and may reside within volatile memory 112 of computer 101 for execution by a processor, such as processor set 110.

Guest management module 210 may perform various operations relating to virtualization of guests/virtual machines by a hypervisor, including creation and management of guests operating systems. Guest management module 210 may include a monitoring function that manages processor execution, including intercepting instructions that require hypervisor control. Guest management module 210 may create guests and isolate guests from each other as well as the underlying hardware. A hypervisor kernel may be included that is similar to an operating system kernel; the hypervisor kernel can manage low-level hardware resources (e.g., processors, memory, I/O) and distribute these resources among the guests. Other functions of guest management module 210 may include memory management functions, a scheduler for shared resources (e.g., physical hardware), security mechanisms, administrative access functions, and the like.

Guest management module 210 may perform interception and interpretation of I/O instructions in conjunction with interception module 220, which is responsible for determining whether a given device's I/O instructions should be interpreted or intercepted. When an instruction is interpreted, the instruction is passed by the hypervisor to a dedicated physical device for execution, and the output is likewise provided back to the guest. In contrast, when an I/O instruction is intercepted, the I/O instruction is simulated by the hypervisor. Thus, interpretation involves instructions to pass from a virtual memory queue of a guest to a physical memory queue of a dedicated physical device, whereas interception further includes a shadow memory queue that that mirrors the state of a guest's virtual queue and forwards data between the virtual queue and a physical device's queue.

Interception module 220 may manage how I/O instructions of a guest are handled by determining whether I/O instructions are intercepted or interpreted. Interception module 220 may implement one or more interception controls, which serve as the mechanism that determines whether I/O instructions of a device are interpreted or intercepted. An interception control can be implemented in various data structures, including a state description and/or a device structure. For example, the interception control may include a bit field having a value of either “0” or “1”, with “0” indicating that interception should be performed and “1” indicating that interpretation should be performed.

In some embodiments, interception module 220 implements an interception control in a state description, which is a data structure that includes information that describes a guest's state. For example, the state description can include values of processor registers, memory contents, states of virtual I/O devices, resource allocation, and the like. An interception control in the state description may operate as a global interception control for all devices of a particular class. For example, the interception control in a state description may control whether the I/O instructions for all of the virtual processors are intercepted or interpreted.

To provide a finer level of granularity, a device-based interception control can be implemented in a data structure referred to as a device structure. A device structure represents a particular virtual device of a guest, and can include the device address, path to the device, buffers that relate to the device, and the like. Since the device structure is device-specific, implementing an interception control in the device structure enables the decision between interpretation and interception to be made on a per-device level.

Interception module 220 may set interception control values in response to various operations occurring and/or instructions provided. In some embodiments, an administrator may provide input to a hypervisor to modify the interception control value for a particular device or class of device. In some embodiments, a trace command may cause an interception control value to be modified. In some embodiments, interception control values are set at instantiation of a guest. in some embodiments, interception control values may be modified based on a device's queue no longer being active. Thus, when a queue becomes inactive, the interception control for a particular virtual device may be reset to a default state (e.g., either interception or interpretation). In some embodiments, the interception control for a particular device or class of devices may be toggled when the particular device (or a device belonging to the class of devices) encounters an error. An interception control may be modified when a program-initiated termination command is encountered (e.g., a clear subchannel command). In some embodiments, an interception control is set to either interception or interpretation in response to a device receiving I/O instructions for the first time during a session. In some embodiments, an interception control can be set in order to initiate or terminate tracing or record-based logging. Interception module 220 may set an interception control for a device in order to enable the hypervisor to manage physical storage that is assigned for buffers.

In some embodiments, the interception control may be set to enable a hypervisor to virtualize a device's address. In this case, interception is performed to translate a virtual address to a real address. In some embodiments, this virtualization can be used to map virtual addresses to a pool of real devices for resilience and/or load-balancing purposes.

In some embodiments, interception module 220 may toggle interception of one or more devices in order to perform live guest relocation (e.g., migrating an executing guest to other physical hardware) by providing virtual addresses so that the guest does not require real device/adapter addresses. This enables equivalent or compatible devices at the destination to be provided without a guest's awareness of the physical substitution. In some embodiments, interception may be deactivated in order to increase performance of a guest.

Tracing module 230 may perform various tracing operations, which can involve tracking and logging of activities of virtual and/or physical devices associated with a guest. As such, tracing module 230 may monitor I/O operations, record device states, and/or identify performance issues or errors. If performance issues are encountered, tracing module 230 can determine the amount of data being written, the time required to perform write operations, the number of errors encountered, and/or any bottlenecks in I/O queues. In particular, when a device is traced, tracing module 230 may issue instructions to interception module to cause I/O instructions from the device being traced to be temporarily intercepted. Thus, using a device-specific interception control, only the I/O instructions of a particular device need to be intercepted, rather than intercepting the I/O instructions for all devices of that class, which enables tracing to be performed in a much less disruptive manner.

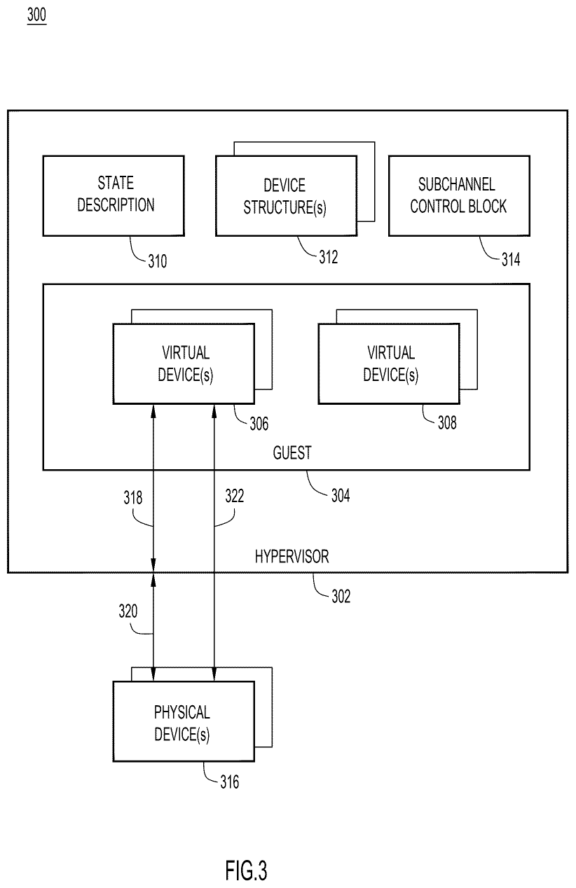

With reference now to FIG. 3, a block diagram is provided of a virtualization environment 300 according to an embodiment of the present invention. As depicted, the virtualization environment 300 includes a hypervisor 302 and at least one guest 304; the guest 304 includes various virtual devices 306 and 308, and the hypervisor 302 includes a state description 310, one or more device structures 312, and a subchannel control block 314. Also included in virtualization environment 300 are one or more physical devices 316, which may correspond to the underlying hardware that is utilized for execution. It should be appreciated that in the example embodiment of virtualization environment 300 only one guest 304 instance is shown; however, hypervisor 302 may host multiple instances of guests.

Virtualization environment 300 may include physical resources including memory, central processing units (CPUs), and the like, as well as virtual devices such as virtual memory, virtual CPUs, and other virtual devices. A virtual resource may be entirely simulated by software within hypervisor 302, or hypervisor 302 can donate a physical resource from a set of physical resources assigned to hypervisor 302 to be exclusively used by a particular guest (e.g., guest 304). In other embodiments, a virtual resource can be partitioned from a larger physical resource assigned to the hypervisor such that the partition (or subset) is donated to the guest. resources donated to a guest may or may not be donated to the guest for the life of the guest or for as long as the guest attempts to retain access. In some embodiments, a resource may remain available to a particular guest for the duration that the guest is actively executing, and reused by other guests when the particular guest no longer running. Donation of resources to guests may be exclusive to a guest or shared by guests. When a resource is shared, two concurrently executing guests can access the same virtual resource.

Hypervisor 302 may include any hypervisor configured to host guests/virtual machines, such as an International Business Machines (IBM) z/VM® hypervisor. As such, guest 304 may include a Linux®, z/OS® and/or z/Transaction Processing Facility (z/TPF) virtual machine. Guest 304 may include one or more virtual devices, which appear to the guest operating system as physical devices but are actually virtualized by the hypervisor 302. The virtual devices can include one or more virtual devices 306 and 308; the distinction between virtual devices 306 and virtual devices 308 indicates that the virtual devices belong to different classes of devices. For example, virtual devices 306 may include virtual processors, whereas virtual devices 308 may include virtual memory. In various embodiments, virtual devices 306 and 308 can include processor devices, memory devices, network devices, storage devices, cryptographic computing devices, graphics cards, or any other I/O devices. In some embodiments, either of virtual devices 306 or virtual devices 308 can include a queued direct input/output (QDIO) device or an enhanced queued direct input/output (EQDIO) device, which are architectures for packeted data transfer. As compared to QDIO devices, EQDIO devices utilize a queue structure that supports a higher transfer rate.

The state description 310 defines interception controls and the state of guest 304 during execution, as well as current I/O operations, memory usage, hardware status, and/or other operational data. Specifically, the state description 310 includes a class-level interception control that determines whether the I/O instructions for all devices of a given class are intercepted or interpreted. The interception control can be a bit that is set to either zero or one in order to define whether I/O instructions are intercepted or interpreted. For the EQDIO architecture, a dedicated execution control field (e.g., “ECD.15”, the fifteenth bit of an execution control (ECD) field, or another field) may serve as the interception control. Thus, if the ECD.15 value is set to zero, then interception occurs for all EQDIO devices, whereas an ECD.15 value of one may cause interpretation (pending a second device-based interception control that is implemented in a device structure 312.

Device structure(s) 312 may be a data structure for a particular virtual device (e.g., any of virtual device(s) 306 or virtual device(s) 308) that represents a device and includes details such as the device's address, the path to the device, as well as any buffers that relate to the device. Thus, there may be a different device structure 312 per each of virtual device(s) 306 and virtual device(s) 308. Each device structure 312 may further include a device-based execution control that enables per-device toggling of interpretation vs. interception. Each device structure 312 may be a queued-buffer information control block (QBICB). A QBICB is a shared structure between millicode and a hypervisor, and can contain information about the buffer storage and buffer states of a guest's queues and corresponding shadow queues of specific subchannels. The device-based execution control can be defined as a new field in the QBICB: a Guest Enable Device Pass-through (GEDP) field (i.e., “QBICB.GEDP”). Thus, the class-level interception control in the state description 310 may initially determines whether a class of devices is intercepted, and if not, then the QBICB. GEDP field controls whether a given device is intercepted or interpreted. According to an embodiment, the millicode logic for the hypervisor 302 is modified as described by the pseudocode:
If ECD. 15=0 then intercept
Else
   If QBICB.GEDP=0 then intercept
   Else
      Interpret the Guest Instruction

Thus, the millicode logic indicates that the hypervisor 302 may first determine whether to intercept I/O instructions for a class of devices, and if the value indicates that interpretation should instead occur, then the hypervisor 302 determines whether interception or interpretation should occur for each virtual device based on the device-based interception control implemented in the device structure 312 of each device.

In some embodiments, the default values for the device-based interception control are enabled when the hypervisor 302 is set for a particular architecture. For example, the when the hypervisor 302 is set for the z architecture, EQDIO instructions may be set to be either intercepted or interpreted (whichever is the desired default behavior), and when the hypervisor 302 selects another architecture (e.g., Enterprise Systems Architecture (ESA) 390 (“ESA/390”), etc.), the interception controls may be switched to a different state. Thus, the interception controls may be set or reset whenever a central processing unit (CPU) architecture is established.

Subchannel control block 314 may include a data structure that is used to store the device-based interception controls for each device. In general, a set of control blocks are allocated in a Hardware System Area (HSA) storage of the hypervisor 302 that is accessible only to the embedded firmware. The control blocks, among which subchannel control block 314 is included, provide communication among the various elements in the virtualization environment 300 and maintain information about the I/O configuration. The subchannel control block 314 contains information that is used to represent the architected subchannel.

In particular, the hypervisor's millicode may interrogate the device structure (e.g., the QBICB) and obtain the device-based interception control values, which are then stored in the subchannel control block 314. Subchannel control block 314 may be provided as a storage area that is used for communication between hypervisor 302 and physical devices 316 via the channel subsystem, and can define paths to devices, parameters to passed upon interrupts, and the like. Once a buffer queue for a virtual device is formally activated, the effects of the class-based interception controls and device-based interception controls become active, the latter of which are determined when the hypervisor 302 accesses the subchannel control block 314.

Thus, the class-based interception controls and the device-based interception controls dictate whether a class of devices or a particular device therein will be subject to either interception or interpretation when the I/O instructions are handled by hypervisor 302. In the case that interception occurs, I/O instructions are intercepted at operation 318 and simulated by the hypervisor 302, which accesses the underlying physical device(s) 316 at operation 320. In the case that interpretation occurs, I/O instructions are provided directly to the physical device(s) 316 at operation 322.

In some embodiments, when an I/O instruction, such as an EQDIO instruction, is issued, a token is passed in a register (e.g., “register 1” or “r1”) of a processor; the token indicates to the hypervisor or to the millicode a particular device connection that is being used. When a token is issued from a guest, the token may indicate the host logical address of the device structure (e.g., the QBICB); the millicode can use this information to locate the QBICB and then the subchannel ID, which corresponds to the real device token (e.g., the physical or virtual device being used for the I/O instructions, which depends on the interception control in the QBICB). In contrast, when the hypervisor issues a token, the token indicates the real device token (e.g., by the subchannel ID). When the hypervisor intercepts and re-issues a guest instruction, the hypervisor may perform the same actions as millicode by converting the guest token to an equivalent host token via the QBICB.

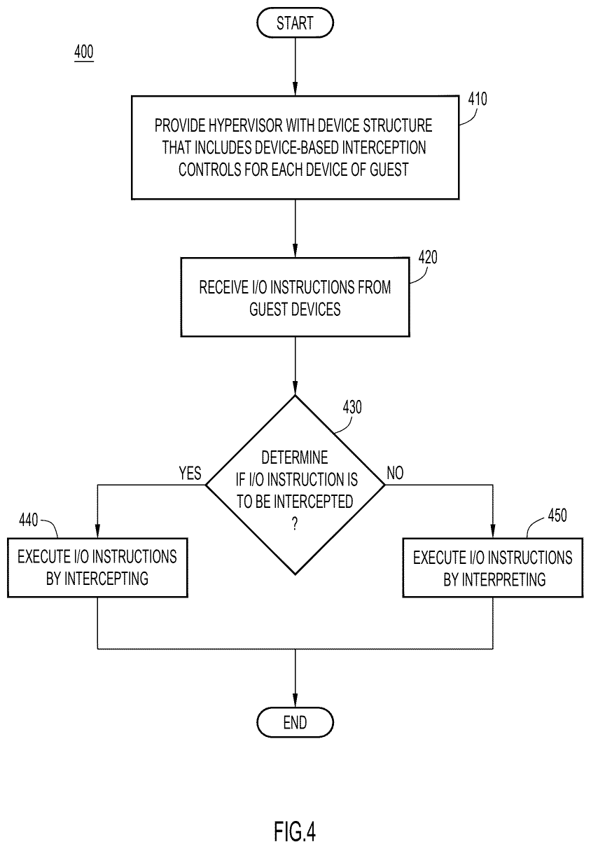

FIG. 4 is a flowchart of a method 400 for executing guest instructions in a hypervisor environment according to an embodiment of the present invention.

A hypervisor is provided with a device structure that includes device-based interception controls for each virtual device of the guest at operation 410. The device-based interception controls may be implemented in a particular data structure that is specific for each virtual device, such as a device structure. The device-based interception control may be implemented in an execution control field, and can be a bit value that indicates whether interception or interpretation should be performed for a given virtual device's I/O instructions. For example, in an EDQIO architecture, the device-based interception control may be implemented in a QBICB field.

I/O instructions are received from the guest devices at operation 420. When I/O instructions are received, millicode may interrogate the device structure that corresponds to the virtual device that issued the instructions. Thus, the device-based interception control value can be obtained, which determines whether the I/O instructions should be interpreted or intercepted.

Operation 430 determines if a particular I/O instruction is to be intercepted. The value of the device-based interception control can be defined such that one value (e.g., zero) means that interception should occur, whereas another value (e.g., one) indicates that interpretation should instead be performed.

If the particular I/O instruction is to be intercepted, the I/O instruction is executed by intercepting the I/O instruction at operation 440. Intercepted instructions are then simulated by the hypervisor and returned to the guest.

If the particular I/O instruction is not to be intercepted, the I/O instruction is executed by interpreting the I/O instruction at operation 450. In this case, the guest is provided with dedicated access to the underlying physical hardware, which executes the instruction and returns the results to the guest.

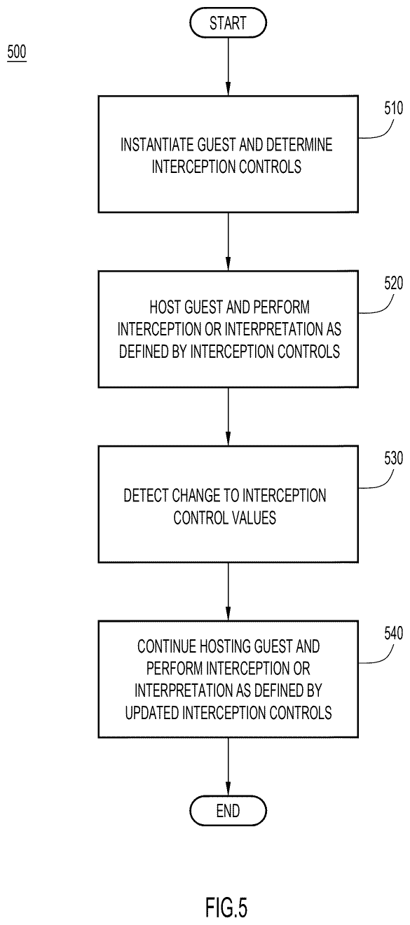

FIG. 5 is a flowchart of a method 500 for performing guest instruction interception control in a hypervisor environment according to an embodiment of the present invention.

A guest is instantiated and interception controls are determined at operation 510. The interception controls for a class of devices may be set whenever a virtual device of that class is created (e.g., when a state description is created), and a default value may be set (e.g., a value indicating that I/O instructions should be intercepted). In contrast, device-based interception control values may be set when a guest establishes communication with a virtual device, such as by issuing a diagnostic instruction (e.g., Hypervisor Call or other similar instructions). This instruction enables tasks to be performed such as allocating buffer queues, checking for interrupts, and/or retrieving network packet statuses. Thus, when a guest issues such an instruction for a particular virtual device, that virtual device's interception control may be set in the device structure (e.g., by setting the QBICB. GEDP bit).

The guest is hosted and interception or interpretation is performed as defined by the interception controls at operation 520. Initially, the class-based interception controls found in the guest's state description may dictate whether a given class of devices are to be intercepted or interpreted. However, if a class of devices is set to be intercepted, individual devices may nevertheless be interpreted according to the device-based interception control value found in each device's device structure (e.g., QBICB).

Once a buffer queue becomes active, the effects of the class-based interception controls and/or the device-based interception controls may remain active until occurrence of a particular event. Thus, interception or interpretation proceeds as defined by the interception controls until one or more events occur. In some embodiments, when a queue ceases to be active, the interception control for that virtual device or class may be reset. In some embodiments, interception controls may be reset when an error is encountered (e.g., when a particular error code is issued by a guest, hypervisor, virtual device, and/or physical device). In some embodiments, interception controls may be reset when a program-initiated termination occurs, which can be indicated by a particular instruction such as a clear subchannel (CSCH) instruction.

In some embodiments, a device-based interception control may be set in response to issuance of a trace command. Trace code in the hypervisor can intercept traced instructions and can record pre-invocation operands and data. Next, the trace code can simulate the intercepted instruction and record post-invocation data prior to returning the instruction to the guest. The manner in which simulation occurs during tracing may differ based on whether a device's instructions are being interpreted or intercepted. Interpreted devices will have a corresponding set of shadow queues defined in memory that the hypervisor uses when relaying guest I/O operations to hardware, which also references the shadow queues. In this case, simulation already occurs. However, for intercepted instructions that receive a dedicated physical device, millicode may access the device structure to obtain a subchannel ID and from that, locate the subchannel control block in the hardware system area. A token may be obtained from a general register of a processor (e.g., r1) that indicates the address of the device structure to the millicode. Thus, when a hypervisor simulates an instruction for tracing purposes of an otherwise-intercepted device, the hypervisor converts the token to the subchannel ID using the device structure (e.g., the QBICB) and then reissues the guest instruction. Note that validation of guest operands may be required to ensure that the hypervisor does not receive an unexpected program exception.

In some embodiments, device-based interception controls may enable device remapping by ensuring that I/O operations of a particular device are always intercepted, in which case the hypervisor can indicate to the guest a fake/alias device number and subchannel token that is in turn mapped to a true device on interception. Thus, if the hypervisor reissues instructions using the real token, the guest remains unaware of the remapping. Remapping in this manner provides several practical applications, such as enabling a hypervisor to perform some pooling operations without a guest's knowledge. Additionally or alternatively, remapping may be performed to facilitate live guest relocation by ensuring in advance that the fake/alias device is mapped or backed by a compatible physical device on both source and target systems. Thus, the alias device number is remapped to a physical device on interception.

In some embodiments, device-based interception controls may be applied to cryptographic devices. Each cryptographic device may be partitioned into a resource that is referred to as a domain, access to which is governed by a number of masks contained within a cryptographic control block (CRYCB) that is implemented as a satellite data structure to the state description. One such mask may specify which cryptographic devices can be accessed; a domain mask may specify which domains can be accessed, and a queue mask may specify which queues a program may enqueue its requests. A queue-based fourth mask may further be defined to act as a device-based interception control, the presence of which can be indicated via an additional CRYCB bit or an additional state description interception bit.

A change to the interception control values is detected at operation 530. In the case of a class-based interception control, a change to the interception control values can be detected by a millicode using a cache line monitor on the state description. In the case of a device-based interception control, a change to the interception control value may be detected whenever instructions are issued by the guest, as the millicode fetches the current setting from the device structure when this occurs.

The hypervisor continues hosting the guest and performs interception or interpretation as defined by the updated interception controls at operation 540. Using the updated interception controls, the I/O instructions of virtual devices are intercepted or interpreted accordingly.

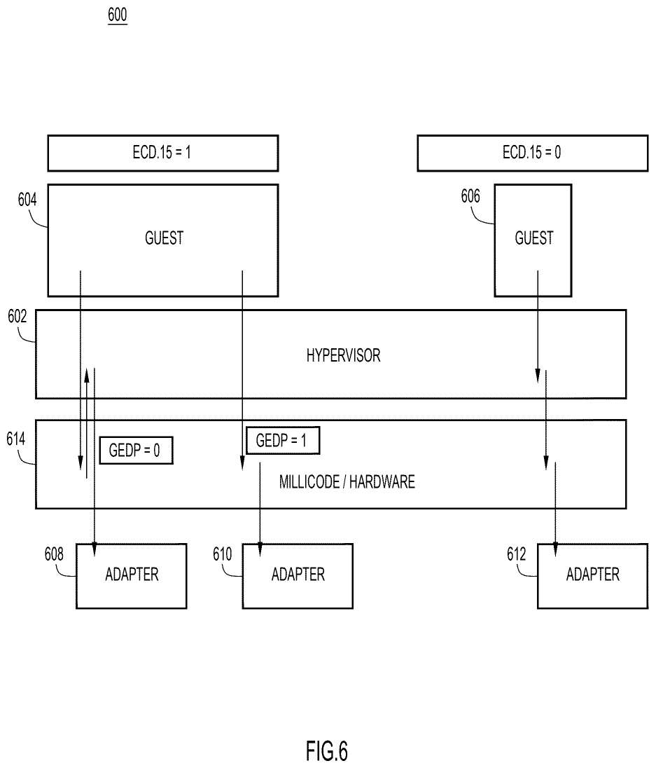

With reference now to FIG. 6, a block diagram is provided of a virtualization environment 600 according to an embodiment of the present invention. As depicted, virtualization environment 600 includes a hypervisor 602, a guest 604 and a guest 606, adapters 608, 610, and 612, and millicode/hardware 614. Virtualization environment 600 is provided as an example of how present embodiments provide greater granularity with respect to control of interception vs. interpretation in a hypervisor environment. In this example, an ECD.15 field value initially determines whether a class of devices is intercepted, and if not, then a QBICB. GEDP field controls whether a given device is intercepted or interpreted. Thus, in the depicted example, the ECD. 15 value of 0 for guest 606 causes I/O instructions of guest 606 to be intercepted by hypervisor 602 and millicode/hardware 614 before passing to adapter 612. In contrast, guest 604 has an ECD.15 value of one, enabling interception controls to be implemented on a per-adapter basis. In this case, the GEDP value controls interception vs. interpretation. As depicted, the GEDP value corresponding to adapter 610 is set to one, meaning that I/O instructions are intercepted with respect to guest 604 and adapter 610. In contrast, the GEDP value associated with adapter 608 is set to zero, causing instructions of guest 604 to be interpreted.

Thus, in virtualization environment 600, if execution of a guest instruction causes an interception event, then hypervisor 602 gains control and simulates the instruction for the guest. If execution of a guest instruction does not cause an interception event, then hypervisor 602 is not involved and the instruction is interpreted by the CPU, meaning that the CPU completes execution of the instruction within the context of the issuing environment (including either the guest or hypervisor). A simulated instruction may result in the same instruction being reissued by the hypervisor in a modified form; or, after activity is performed by the hypervisor to enable the guest to issue subsequent instructions of this type without interception, the hypervisor nullifies the instruction and reruns the guest so that the guest may reissue the same and subsequent instructions without interception, or the instruction is simulated within the hypervisor by other instructions.

It will be appreciated that the embodiments described above and illustrated in the drawings represent only a few of the many ways of implementing embodiments for device-specific interception of I/O instructions in a hypervisor environment.

The environment of the present invention embodiments may include any number of computer or other processing systems (e.g., any computing device, computing service, etc.) and databases or other repositories arranged in any desired fashion, where the present invention embodiments may be applied to any desired type of computing environment (e.g., cloud computing, client-server, network computing, mainframe, stand-alone systems, etc.). The computer or other processing systems employed by the present invention embodiments may be implemented by any number of any personal or other type of computer or processing system. These systems may include any types of monitors and input devices (e.g., keyboard, mouse, voice recognition, etc.) to enter and/or view information.

It is to be understood that the software of the present invention embodiments (e.g., hypervisor code 200, elements of virtualization environment 300, etc.) may be implemented in any desired computer language and could be developed by one of ordinary skill in the computer arts based on the functional descriptions contained in the specification and flowcharts illustrated in the drawings. Further, any references herein of software performing various functions generally refer to computer systems or processors performing those functions under software control. The computer systems of the present invention embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present invention embodiments may be distributed in any manner among the various end-user/client, distributed computing, and server systems, and/or any other intermediary processing devices. The software and/or algorithms described above and illustrated in the flowcharts may be modified in any manner that accomplishes the functions described herein. In addition, the functions in the flowcharts or description may be performed in any order that accomplishes a desired operation.

The communication network may be implemented by any number of any type of communications network (e.g., LAN, WAN, Internet, Intranet, VPN, etc.). The computer or other processing systems of the present invention embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

The system may employ any number of any conventional or other databases, data stores or storage structures (e.g., files, databases, data structures, data or other repositories, etc.) to store information. The database system may be implemented by any number of any conventional or other databases, data stores or storage structures (e.g., files, databases, data structures, data or other repositories, etc.) to store information. The database system may be included within or coupled to the computing system. The database systems and/or storage structures may be remote from or local to the computer or other processing systems, and may store any desired data.

The present invention embodiments may employ any number of any type of user interface (e.g., Graphical User Interface (GUI), command-line, prompt, etc.) for obtaining or providing information (e.g., guest data, virtual device data, hypervisor data, buffer queue data, interception control data, etc.), where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

The guest data, virtual device data, hypervisor data, buffer queue data, interception control data, and/or any other data may include any information arranged in any fashion, and may be configurable based on rules or other criteria to provide desired information to a user.

The present invention embodiments are not limited to the specific tasks or algorithms described above, but may be utilized for selectively controlling virtualization of any guest elements in any virtualization environment.

The data may include any format of storing data and may include any data descriptive of databases, including metadata and indexes thereof. The data may be obtained via any techniques, and may be accessed over a network, fetched from local storage, provided via user input, and the like.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes”, “including”, “has”, “have”, “having”, “with” and the like, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
providing a hypervisor with a device structure that includes a device-based interception control value for each of a plurality of devices of a guest of the hypervisor, wherein each device-based interception control value indicates whether input/output (I/O) of a particular device is intercepted or interpreted by the hypervisor;
receiving, from the plurality of devices of the guest, I/O instructions;
determining, by the hypervisor, that a particular I/O instruction for each device are to be intercepted or interpreted by the hypervisor based on the device-based interception control value of each device; and
executing the I/O instructions by intercepting each I/O instruction issued by each particular device that is determined to be intercepted and interpreting each I/O instruction issued by each particular device that is determined to be interpreted.

2. The computer-implemented method of claim 1, further comprising:
determining, by the hypervisor, that I/O instructions for each device of a particular device class are to be intercepted or interpreted by the hypervisor based on a class-based interception control value stored in a state description of the hypervisor.

3. The computer-implemented method of claim 1, wherein the device-based interception control value for a particular device is reset in response to a selection from a group consisting of:
a queue for the particular device becoming inactive, an error being encountered for the particular device, and a clear subchannel instruction being provided by the particular device.

4. The computer-implemented method of claim 1, further comprising:
resetting the device-based interception control value for a selected device to cause I/O instructions of the selected device to be intercepted rather than interpreted.

5. The computer-implemented method of claim 1, further comprising:
interrogating the device structure for each of the plurality of devices to obtain each device-based interception control value; and
storing each device-based interception control value in a subchannel control block structure.

6. The computer-implemented method of claim 1, wherein a trace command issued by the hypervisor for a selected device causes I/O instructions of the selected device to be intercepted.

7. The computer-implemented method of claim 1, wherein a remapping command issued by the hypervisor for a selected device causes the hypervisor to indicate an alias device number to the guest of the selected device, and wherein the alias device number is remapped to a physical device on interception.

8. A computer system comprising:
one or more memories; and
at least one processor coupled to the one or more memories, wherein the at least one processor is configured to:
provide a hypervisor with a device structure that includes a device-based interception control value for each of a plurality of devices of a guest of the hypervisor, wherein each device-based interception control value indicates whether input/output (I/O) of a particular device is intercepted or interpreted by the hypervisor;
receive, from the plurality of devices of the guest, I/O instructions;
determine, by the hypervisor, that a particular I/O instruction for each device are to be intercepted or interpreted by the hypervisor based on the device-based interception control value of each device; and
execute the I/O instructions by intercepting each I/O instruction issued by each particular device that is determined to be intercepted and interpreting each I/O instruction issued by each particular device that is determined to be interpreted.

9. The computer system of claim 8, wherein the at least one processor is further configured to:
determine, by the hypervisor, that I/O instructions for each device of a particular device class are to be intercepted or interpreted by the hypervisor based on a class-based interception control value stored in a state description of the hypervisor.

10. The computer system of claim 8, wherein the device-based interception control value for a particular device is reset in response to a selection from a group consisting of: a queue for the particular device becoming inactive, an error being encountered for the particular device, and a clear subchannel instruction being provided by the particular device.

11. The computer system of claim 8, wherein the at least one processor is further configured to:
reset the device-based interception control value for a selected device to cause I/O instructions of the selected device to be intercepted rather than interpreted.

12. The computer system of claim 8, wherein the at least one processor is further configured to:
interrogate the device structure for each of the plurality of devices to obtain each device-based interception control value; and
store each device-based interception control value in a subchannel control block structure.

13. The computer system of claim 8, wherein a trace command issued by the hypervisor for a selected device causes I/O instructions of the selected device to be intercepted.

14. The computer system of claim 8, wherein a remapping command issued by the hypervisor for a selected device causes the hypervisor to indicate an alias device number to the guest of the selected device, and wherein the alias device number is remapped to a physical device on interception.

15. A computer program product, the computer program product comprising one or more computer readable storage media having program instructions collectively stored on the one or more computer readable storage media, the program instructions executable by at least one processor to cause the at least one processor to:
provide a hypervisor with a device structure that includes a device-based interception control value for each of a plurality of devices of a guest of the hypervisor, wherein each device-based interception control value indicates whether input/output (I/O) of a particular device is intercepted or interpreted by the hypervisor;
receive, from the plurality of devices of the guest, I/O instructions;
determine, by the hypervisor, that a particular I/O instruction for each device are to be intercepted or interpreted by the hypervisor based on the device-based interception control value of each device; and
execute the I/O instructions by intercepting each I/O instruction issued by each particular device that is determined to be intercepted and interpreting each I/O instruction issued by each particular device that is determined to be interpreted.

16. The computer program product of claim 15, wherein the program instructions further cause the at least one processor to:
determine, by the hypervisor, that I/O instructions for each device of a particular device class are to be intercepted or interpreted by the hypervisor based on a class-based interception control value stored in a state description of the hypervisor.

17. The computer program product of claim 15, wherein the device-based interception control value for a particular device is reset in response to a selection from a group consisting of:
a queue for the particular device becoming inactive, an error being encountered for the particular device, and a clear subchannel instruction being provided by the particular device.

18. The computer program product of claim 15, wherein the program instructions further cause the at least one processor to:
reset the device-based interception control value for a selected device to cause I/O instructions of the selected device to be intercepted rather than interpreted.

19. The computer program product of claim 15, wherein the program instructions further cause the at least one processor to:
interrogate the device structure for each of the plurality of devices to obtain each device-based interception control value; and
store each device-based interception control value in a subchannel control block structure.

20. The computer program product of claim 15, wherein a trace command issued by the hypervisor for a selected device causes I/O instructions of the selected device to be intercepted.
